(19) United States
(12) Patent Application Publication
(10) Pub. No.: US 2014/0329512 A1
(43) Pub. Date: Nov. 6, 2014

(54) Method and Apparatus for Silencing a Communications Device

(71) Applicant: James H. Philip, Chestnut Hill (Brookline), MA (US)

(72) Inventor: James H. Philip, Chestnut Hill (Brookline), MA (US)

(21) Appl. No.: 13/875,626

(22) Filed: May 2, 2013

(51) Int. Cl. H04M 1/725; H04W 4/12

(52) U.S. Cl. CPC H04M 1/72577; H04W 4/12
USPC 455/418; 455/567

(57) ABSTRACT

A method, apparatus and computer program product for silencing a communications device is presented. A disable signal is received wirelessly from an external source at the communications device. In response to receiving the disable signal, notifications related to the communications device are disabled.

### BACKGROUND

Communications devices have become increasingly popular. Communications devices include, but are not limited to, a cellular telephone; a smart phone (e.g. an IPhone® or an Android®); a tablet device (e.g., an IPad® or a Galaxy®); a book reader (e.g. Kindle®); a portable computer (e.g., a Lenovo ThinkPad®); a media player (e.g. an IPod Touch®) and a Personal Digital Assistant (PDA, such as a Palm Pilot®). Most communications devices are capable of providing notifications to the user when a certain event occurs.

At certain times, the notifications provided by the communications devices are undesired. Typically at an event such as an opera performance, movie, ceremony (such as a wedding or religious event) or the like, a user of a communications device is requested to silence their communications device, in order to avoid an interruption of the event taking place or others attending the event.

### SUMMARY

Conventional mechanisms such as those explained above suffer from a variety of deficiencies. One deficiency is that the user has to manually silence their communications device for the duration of the event, and may forget to enable the communication device notifications after the event is over. During an intermission of the event taking place, the user may enable communication device notifications, and forget to disable the device when the intermission is over and the event has resumed. Other issues regarding disabling and enabling communication device notifications are also cause for concern.

Embodiments of the invention significantly overcome such deficiencies and provide mechanisms and techniques that provide a method and apparatus for silencing a communications device.

In a particular embodiment of a method for silencing a communications device, the method includes wirelessly receiving, from an external source, a disable signal at the communications device. The method further includes, in response to receiving the disable signal, disabling notifications related to the communications device.

Other embodiments include a computer readable medium having computer readable code thereon for silencing a communications device. The computer readable medium includes instructions for wirelessly receiving, from an external source, a disable signal at the communications device. The computer readable medium further includes instructions for, in response to receiving the disable signal, disabling notifications related to the communications device.

Still other embodiments include a computerized device (e.g. a communications device), configured to process all the method operations disclosed herein as embodiments of the invention. In such embodiments, the computerized device includes a memory system, a processor, communications interface in an interconnection mechanism connecting these components. The memory system is encoded with a process that silences a communications device as explained herein that when performed (e.g. when executing) on the processor, operates as explained herein within the computerized device to perform all of the method embodiments and operations explained herein as embodiments of the invention. Thus any computerized device that performs or is programmed to perform the processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations silencing a communications device as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates an environment in accordance with embodiments of the invention;

FIG. 2 depicts a flow diagram of a particular embodiment of a method for silencing a communications device in accordance with embodiments of the invention; and

FIG. 3 illustrates an example system architecture for a communications device that provides silencing of the communications device in accordance with embodiments of the invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements.

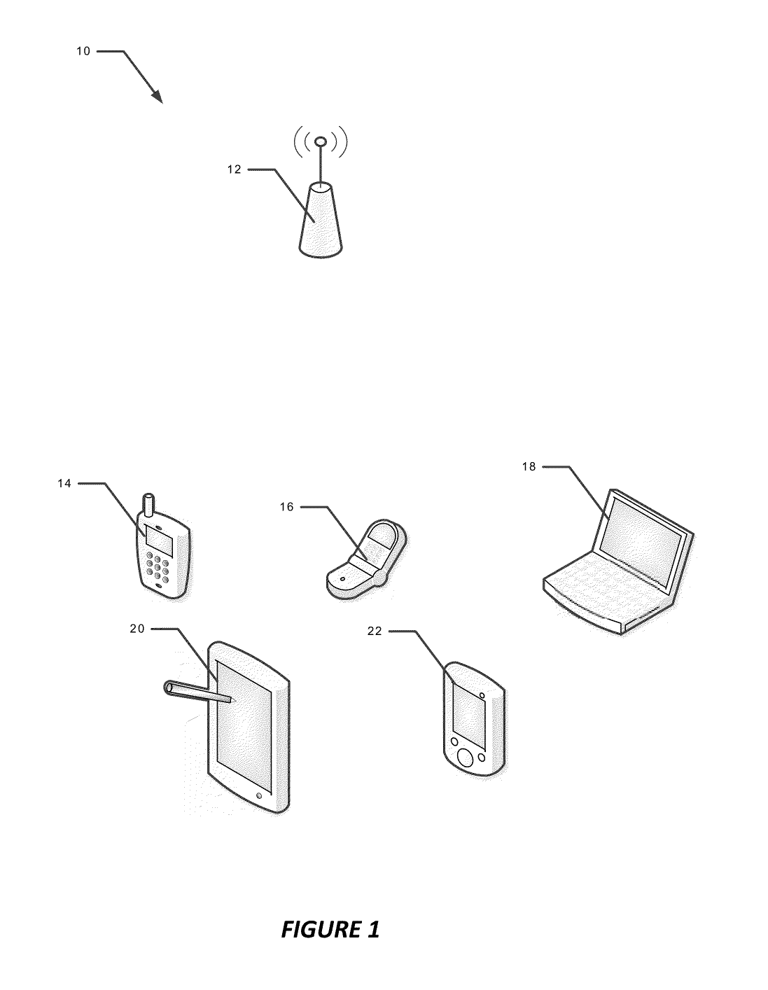

Referring now to FIG. 1, an environment 10 is shown. The environment 10 includes a station 12 which is capable of wirelessly communicating with one or more communication devices. The communication deices shown in this example comprise a smart phone 14, a cellular telephone 16, a laptop computer 18, a tablet 20 and a PDA 22. While only a five communication devices are shown, it should be appreciated that any number of communication devices could be used. Further, while only a few types of communication devices are shown, it should be appreciated that any type of communications device could be used.

Station 12 communicates wirelessly with communication devices 14, 16, 18, 20 and 22. The communication may be of any wireless communication including but not limited to, Wireless Fidelity (WIFI) signals, Radio Frequency (RF) signals, cellular signals, and Bluetooth signals. In one embodiment the communication from station 12 to the communication devices comprises a disable signal. The disable signal may have different effects on different communication devices. For example, for cellular telephone 16, the disable signal may serve to disable notifications regarding incoming calls (e.g., ring tones) and incoming text messages. The disable signal received by smart phone 14 may serve to not only to disable notifications regarding incoming calls (e.g., ring tones) and incoming text messages but also for requests to accept a video call (e.g. Facetime® or Skype®), incoming emails, a social networking update, etc. Other notifications that could also be disabled are notifications relating to signal strength, battery life or the like.

The communication from station 12 may also include an enable signal to enable notifications on the mobile communications device. For example, if a user was attending an event, station 12 may send out a disable signal before the event is about to begin. During intermission, the station could send out an enable signal to the communication device and allow notifications to take place. When intermission is over, station 12 sends out a disable signal so the second half of the event is not disrupted, then after the event is over, an enable signal may be provided by station 12 to enable notifications for the communications device. All this is done without user intervention, although the user could have the option of manually enabling notification on his or her communications device. Further, there could be a predetermined time period during which notifications are disabled, and after which notifications are enabled.

Other embodiments include wherein, in response to receiving a disable signal the communications device is set to a vibrate mode. In this mode, the user is made aware of the notification but the notification does not disturb the event or other attendees of the event. In another embodiment an application may be loaded on the communications device (e.g., from an online application store), the application responsive to the disable signal and the enable signal. In another embodiment the disable signal causes the communications device to power off.

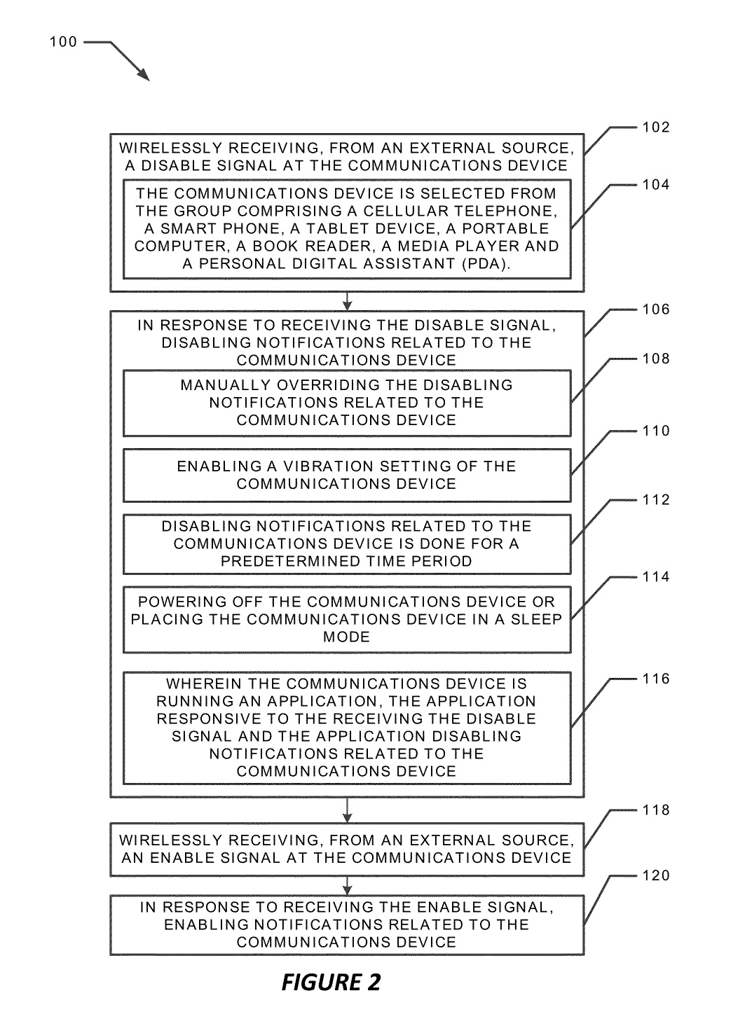

Referring now to FIG. 2, a flow diagram of a particular embodiment of the presently disclosed method is depicted. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Method 100 begins with processing block 102 which discloses wirelessly receiving, from an external source, a disable signal at the communications device. The disable signal may be any type of wireless signal, including but not limited to Wireless Fidelity (WIFI) signals, Radio Frequency (RF) signals, cellular signals, and Bluetooth signals. Processing block 104 states the communications device is selected from the group comprising a cellular telephone, a smart phone, a tablet device, a portable computer, a book reader, a media player and a Personal Digital Assistant (PDA). Other wireless communications devices could also be used.

Processing block 106 recites in response to receiving the disable signal, disabling notifications related to the communications device. The disable signal may have different effects on different communication devices. For example, for a cellular telephone the disable signal may serve to disable notifications regarding incoming calls (e.g., ring tones) and incoming text messages. The disable signal received by a smart phone may serve to not only to disable notifications regarding incoming calls (e.g., ring tones) and incoming text messages but also for requests to accept a video call (e.g. Facetime® or Skype®), incoming emails, a social networking update, etc. Other notifications that could also be disabled are notifications relating to signal strength or battery life.

As shown in processing block 108, disabling notifications may include allowing the communications device user to manually override the disabling of notifications related to the communications device. If the user were to leave the event prior to the enable notifications signal being received, the user can manually enable the communications device to provide notifications.

Processing block 110 shows wherein the disabling notifications related to the communications device further comprises enabling a vibration setting of the communications device. This allows the user to be notified but does not interrupt the event or is detectable by other attendees of the event.

Processing block 112 discloses wherein the disabling notifications related to the communications device are done for a predetermined time period. This may be done for example for a two hour time period when the event is a movie lasting less than two hours. Accordingly, there is no need to send an enable signal.

Processing block 114 states wherein the disabling notifications related to the communications device comprises powering off the communications device or placing the communications device in a sleep mode. Typically, the user would have to power-on the device after the event is over, although in certain embodiments the device may be powered back on by the enable signal being received.

Referring now to processing block 116 on some devices an application may be downloaded and used to provide this functionality. The application may be loaded on the communications device (e.g., from an online application store), the application responsive to the disable signal and the enable signal.

Processing block 118 discloses wirelessly receiving, from an external source, an enable signal at said communications device. The enable signal may be any type of wireless signal, including but not limited to Wireless Fidelity (WIFI) signals, Radio Frequency (RF) signals, cellular signals, and Bluetooth signals.

Processing block 120 recites in response to receiving the enable signal, enabling notifications related to the communications device.

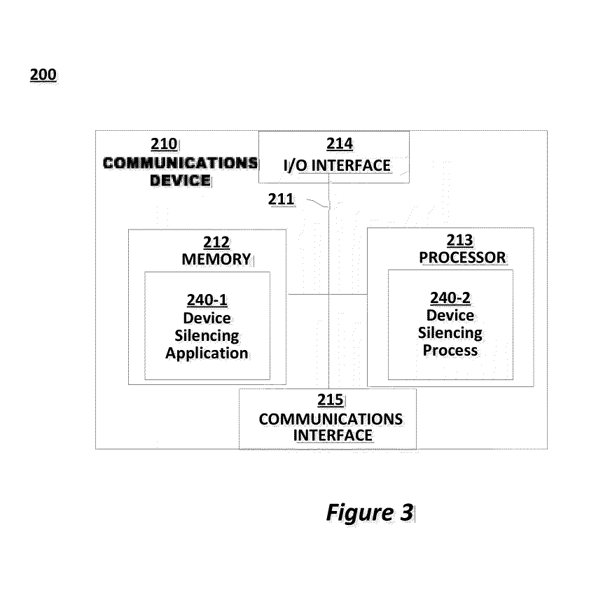

FIG. 3 is a block diagram illustrating example architecture of a communications device 210 that executes, runs, interprets, operates or otherwise performs a communications device silencing operating application 240-1 and communications device silencing operating process 240-2 suitable for use in explaining example configurations disclosed herein. As shown in this example, the communications device 210 includes an interconnection mechanism 211 such as a data bus or other circuitry that couples a memory system 212, a processor 213, an input/output interface 214, and a communications interface 215. The communications interface 215 enables the communications device 210 to communicate with other devices.

The memory system 212 is any type of computer readable medium, and in this example, is encoded with a communications device silencing operating application 240-1 as explained herein. The communications device silencing operating application 240-1 may be embodied as software code such as data and/or logic instructions (e.g., code stored in the memory) that supports processing functionality according to different embodiments described herein. During operation of the communications device 210, the processor 213 accesses the memory system 212 via the interconnect 211 in order to launch, run, execute, interpret or otherwise perform the logic instructions of a communications device silencing operating application 240-1. Execution of a communications device silencing operating application 240-1 in this manner produces processing functionality in the communications device silencing operating process 240-2. In other words, the communications device silencing operating process 240-2 represents one or more portions or runtime instances of a communications device silencing operating application 240-1 (or the entire a communications device silencing operating application 240-1) performing or executing within or upon the processor 213 in the computerized device 210 at runtime.

It is noted that example configurations disclosed herein include the communications device silencing operating application 240-1 itself (i.e., in the form of un-executed or non-performing logic instructions and/or data). A communications device silencing operating application 240-1 may also be stored in a memory system 212 such as in firmware, read only memory (ROM), or, as in this example, as executable code in, for example, Random Access Memory (RAM). In addition to these embodiments, it should also be noted that other embodiments herein include the execution of a communications device silencing operating application 240-1 in the processor 213 as the communications device silencing operating process 240-2. Those skilled in the art will understand that the communications device 210 may include other processes and/or software and hardware components, such as an operating system not shown in this example.

During operation, processor 213 of communications device 200 accesses memory system 212 via the interconnect 211 in order to launch, run, execute, interpret or otherwise perform the logic instructions of the communications device silencing application 240-1. Execution of communications device silencing application 240-1 produces processing functionality in communications device silencing process 240-2. In other words, the communications device silencing process 240-2 represents one or more portions of the communications device silencing application 240-1 (or the entire application) performing within or upon the processor 213 in the communications device 200.

It should be noted that, in addition to the communications device silencing process 240-2, embodiments herein include the communications device silencing application 240-1 itself (i.e., the un-executed or non-performing logic instructions and/or data). The communications device silencing application 240-1 can be stored in a memory type system such as in firmware, read only memory (ROM), or, as in this example, as executable code within the memory system 212 (e.g., within Random Access Memory or RAM).

In addition to these embodiments, it should also be noted that other embodiments herein include the execution of communications device silencing application 240-1 in processor 213 as the communications device silencing process 240-2. Those skilled in the art will understand that the computer system 200 can include other processes and/or software and hardware components, such as an operating system that controls allocation and use of hardware resources associated with the computer system 200.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. References to a network, unless provided otherwise, may include one or more intranets and/or the Internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer usable medium. For example, such a computer usable medium can include a readable memory device having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A computer-implemented method in which a communications device performs operations comprising:
wirelessly receiving, from an external source, a disable signal at said communications device; and
in response to receiving said disable signal, disabling notifications related to said communications device.

2. The method of claim 1 further comprising wirelessly receiving, from an external source, an enable signal at said communications device; and
in response to receiving said enable signal, enabling notifications related to said communications device.

3. The method of claim 1 further comprising manually overriding said disabling notifications related to said communications device.

4. The method of claim 1 wherein said disabling notifications related to said communications device further comprises enabling a vibration setting of said communications device.

5. The method of claim 1 wherein said communications device is selected from the group comprising a cellular telephone, a smart phone, a tablet device, a portable computer, a book reader, a media player and a Personal Digital Assistant (PDA).

6. The method of claim 1 wherein said disabling notifications related to said communications device is done for a predetermined time period

7. The method of claim 1 wherein said disabling notifications related to said communications device comprises powering off said communications device or placing said communications device in a sleep mode.

8. The method of claim 1 wherein said communications device is running an application, said application responsive to said receiving said disable signal and said application disabling notifications related to said communications device.

9. A non-transitory storage medium having readable code thereon for silencing a communication s device, the medium including instructions in which a communications device performs operations comprising:
wirelessly receiving, from an external source, a disable signal at said communications device; and
in response to receiving said disable signal, disabling notifications related to said communications device.

10. The storage medium of claim 9 further comprising wirelessly receiving, from an external source, an enable signal at said communications device; and
in response to receiving said enable signal, enabling notifications related to said communications device.

11. The storage medium of claim 9 further comprising manually overriding said disabling notifications related to said communications device.

12. The storage medium of claim 9 wherein said disabling notifications related to said communications device further comprises enabling a vibration setting of said communications device.

13. The storage medium of claim 9 wherein said communications device is selected from the group comprising a cellular telephone, a smart phone, a tablet device, a portable computer, a book reader, a media player and a Personal Digital Assistant (PDA).

14. The storage medium of claim 9 wherein said disabling notifications related to said communications device is done for a predetermined time period or placing said communications device in a sleep mode.

15. The storage medium of claim 9 wherein said disabling notifications related to said communications device comprises powering off said communications device.

16. The storage medium of claim 9 wherein said communications device is running an application, said application responsive to said receiving said disable signal and said application disabling notifications related to said communications device.

17. A communications device comprising:
a memory;
a processor;
a communications interface;
an interconnection mechanism coupling the memory, the processor and the communications interface; and
wherein the memory is encoded with an application providing silencing of said communication s device, that when performed on the processor, provides a process for processing information, the process causing the communication s device to perform the operations of:
wirelessly receiving, from an external source, a disable signal at said communications device; and
in response to receiving said disable signal, disabling notifications related to said communications device.

18. The communications device of claim 17 further comprising wirelessly receiving, from an external source, an enable signal at said communications device; and
in response to receiving said enable signal, enabling notifications related to said communications device.

19. The communications device of claim 17 further comprising manually overriding said disabling notifications related to said communications device.

20. The communications device of claim 17 wherein said disabling notifications related to said communications device further comprises one of the group comprising: enabling a vibration setting of said communications device; is done for a predetermined time period; powering off said communications device; placing said communications device in a sleep mode; and wherein said communications device is running an application, said application responsive to said receiving said disable signal and said application disabling notifications related to said communications device.
